(19) United States
(12) Patent Application Publication
(10) Pub. No.: US 2013/0044745 A1
(43) Pub. Date: Feb. 21, 2013

(54) COMMUNICATION APPARATUS, COMMUNICATION METHOD, AND COMPUTER PRODUCT

(71) Applicant: Nobutaka IMAMURA, Kawasaki (JP)

(72) Inventor: Nobutaka IMAMURA, Kawasaki (JP)

(73) Assignee: FUJITSU LIMITED, Kawasaki-shi (JP)

(21) Appl. No.: 13/523,959

(22) Filed: Jun. 15, 2012

(30) Foreign Application Priority Data
Aug. 18, 2011 (JP) 2011-179255

(51) Int. Cl. H04L 12/28

(52) U.S. Cl. 370/351

(57) ABSTRACT

A communication apparatus communicates with a plurality of transmission sources and includes an interface that receives from a given transmission source among the transmission sources, a request notification that concerns a transmission right permitting transmission from the given transmission source to the communication apparatus and that includes information identifying a volume of data to be transmitted to the communication apparatus; and a processor that based on the received request notification, judges whether the given transmission source is to be granted the transmission right, where the interface transmits the transmission right to the given transmission source that has been judged to be granted the transmission right.

### CROSS REFERENCE TO RELATED APPLICATIONS

This application is based upon and claims the benefit of priority of the prior Japanese Patent Application No. 2011-179255, filed on Aug. 18, 2011, the entire contents of which are incorporated herein by reference.

### FIELD

The embodiment discussed herein is related to a communication apparatus, communication method, and computer product.

### BACKGROUND

In processing fields that use distributed parallel computers such as clusters, a communication counterpart may communicate a large volume of messages in the course of processing. When this occurs, message communication may concentrate temporarily at a portion of the communication apparatuses, whereby data collision occurs on the network, resulting in network congestion.

A conventional technology transmits to the destination of a message, a request for a transmission right and only when a transmission right called a token is received from the destination is the message transmitted, thereby by avoiding message collision (see, for example, Japanese Laid-Open Patent Publication No. 2001-320385). A related technology retransmits the request for a transmission right when a transmission right is not obtained (see, for example, Japanese Laid-Open Patent Publication No. H11-341107).

A further related technology collectively transmits messages according to communication counterpart and thereby improves network throughput (see, for example, Published Japanese-Translation of PCT Application, Publication No. H7-93636). Yet another related technology improves network throughput by including the data size allowed to be transmitted in the transmission right (see, for example, Japanese Laid-Open Patent Publication No. 2002-261786). Moreover, another related technology adjusts the transmission time slots allocated to subordinate stations by a parent station. Also, refer to Japanese Laid-Open Patent Publication No. 2000-244527 for examples.

Nonetheless, with the technologies above, whether a transmission right is granted is determined based on a one-to-one relationship between the transmission source and the destination and a many-to-one relationship thereof is not considered. Consequently, a transmission right may be given to a communication apparatus having a smaller volume of unsent messages before a communication apparatus that has a large volume of unsent messages and warrants priority to perform transmission. In this case, a problem arises in that at the communication apparatus, memory in the buffer storing unsent messages may become insufficient. Further, the transmission right may be given to a communication apparatus that has waited to receive the transmission right for less time than another communication that has waited a longer time. In this case, during communication, the message transmission deadline may be missed, resulting in processing delays and/or processing error.

### SUMMARY

According to an aspect of an embodiment, a communication apparatus communicates with multiple transmission sources and includes an interface that receives from a given transmission source among the transmission sources, a request notification that concerns a transmission right permitting transmission from the given transmission source to the communication apparatus and that includes information identifying a volume of data to be transmitted to the communication apparatus; and a processor that based on the received request notification, judges whether the given transmission source is to be granted the transmission right, where the interface transmits the transmission right to the given transmission source that has been judged to be granted the transmission right.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1 and 2 are diagrams of communication by a communication apparatus.

FIG. 3 is a block diagram of an example of a hardware configuration of a communication apparatus N according to an embodiment.

FIG. 4 is a diagram of a transmitted-length log stored in a RAM 303 depicted in FIG. 3.

FIG. 5 is a diagram depicting the contents of a transmission request log stored in the RAM 303 depicted in FIG. 3.

FIG. 6 is a diagram depicting the contents of a request token latency log stored in the RAM 303 depicted in FIG. 3.

FIG. 7 is a diagram depicting the contents of a transmitted-throughput log stored in the RAM 303 depicted in FIG. 3.

FIG. 8 is a diagram depicting the contents of a received-throughput log stored in the RAM 303 depicted in FIG. 3.

FIG. 9 is a diagram depicting the contents of issued permission token count information stored in the RAM 303 depicted in FIG. 3.

FIG. 10 is a diagram depicting the contents of an issued permission token log stored in the RAM 303 depicted in FIG. 3.

FIG. 11 is a diagram depicting the contents of a communication counterpart list stored in the RAM 303 depicted in FIG. 3.

FIG. 12 is a diagram depicting the contents of a request token list stored in the RAM 303 depicted in FIG. 3.

FIG. 13 is a diagram depicting the contents of a permission token list stored in the RAM 303 depicted in FIG. 3.

FIG. 14 is a block diagram depicting an example of a functional configuration of the communication apparatus N as a receiver of message M.

FIG. 15 is a block diagram depicting an example of a functional configuration of the communication apparatus N as a transmitter of message M.

FIG. 16 is a flowchart of initialization processing.

FIG. 17 is a flowchart of application-use registration processing.

FIG. 18 is a diagram depicting the contents of request token transmission.

FIG. 19 is a flowchart of buffer management processing.

FIG. 20 is a flowchart of request token transmission processing.

FIG. 21 is a diagram of permission token transmission.

FIG. 22 is a diagram of permission token transmission that is based on a request token that includes the buffered volume for another destination.

FIG. 23 is a flowchart of permission token transmission processing.

FIG. 24 is a flowchart of message transmission processing.

FIG. 25 is a flowchart of message reception processing.

### DESCRIPTION OF EMBODIMENTS

Preferred embodiments of the present invention will be explained with reference to the accompanying drawings. A communication apparatus according to the present invention buffers according to destination, data that is to be transmitted.

Here, to control the data volume on a network and suppress congestion, a transmission-side communication apparatus notifies a reception-side communication apparatus that is a destination of data that is buffered, of a transmission right request that includes information indicating the volume of buffered data. After giving notification of the transmission right request, the transmission-side communication apparatus does not transmit the buffered data until a transmission right is obtained from the reception-side communication apparatus.

Meanwhile, the reception-side communication apparatus receives from transmission-side communication apparatuses that transmit data to the reception-side communication apparatus, transmission right requests indicating the volume of buffered data. The reception-side communication apparatus gives a transmission right to the transmission-side communication apparatus having a buffer that is under the greatest pressure.

Thus, a communication apparatus, a communication method, and a computer product according to the present invention grant transmission rights and thereby enable the volume of data on the network to be controlled, collisions to be avoided, and pressure on the network to be suppressed.

Further, the reception-side communication apparatus refers to the volume of data respectively buffered by multiple transmission-side communication apparatuses and determines the transmission-side communication apparatuses that are to be granted a transmission right. Therefore, transmission rights can be granted such that throughput over the entire network, not just the throughput between communication apparatuses one-to-one, is improved. Further, the communication apparatus, the communication method, and the computer product according to the present invention buffer data according to destination, enabling throughput to be improved.

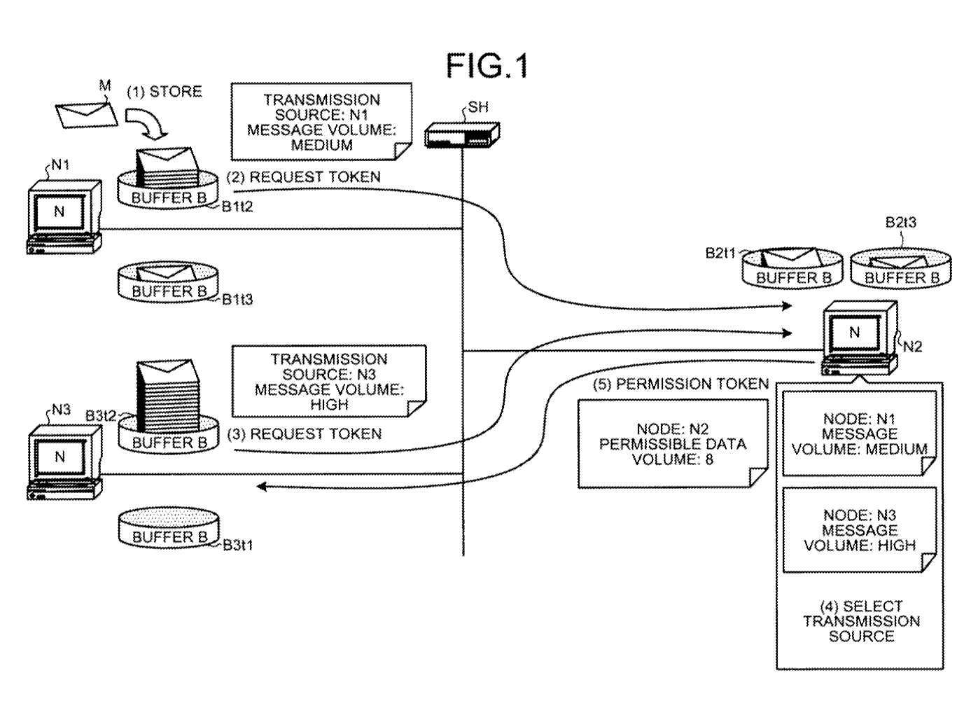

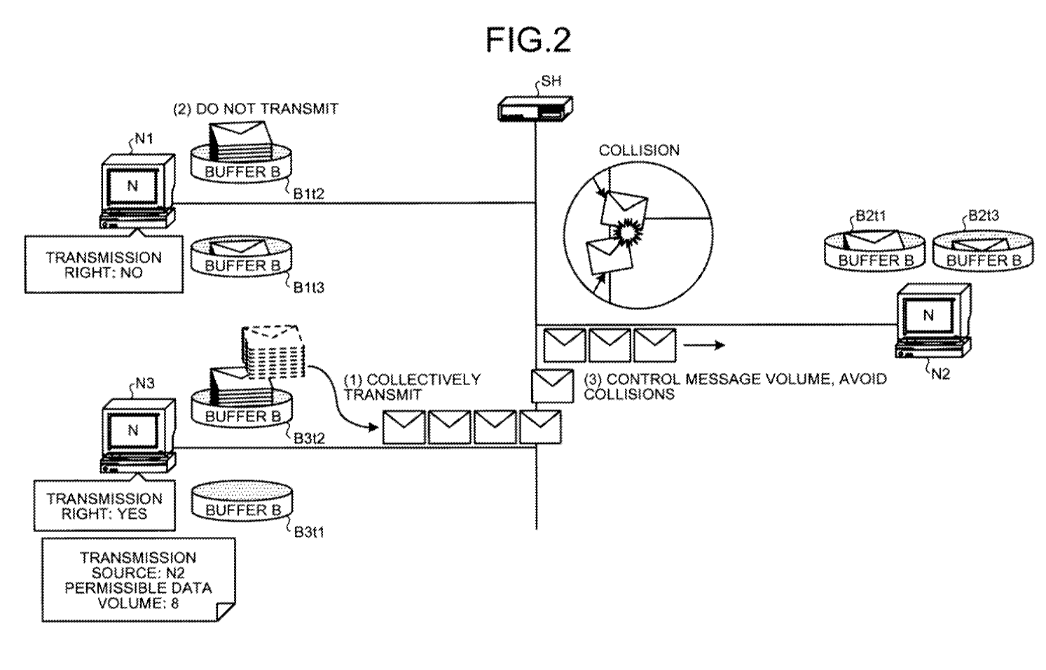

FIGS. 1 and 2 are diagrams of communication by the communication apparatus. Here, a communication system depicted in FIGS. 1 and 2 is a system of multiple communication apparatuses N (in FIGS. 1 and 2, for example, 3 communication apparatuses N1 to N3) connected via a network. The communication system communicates message M and includes a switching hub SH, which is a device that performs interrupts on the network.

Each communication apparatus N has for each destination communication apparatus N, a buffer B that buffers message M (data). Message M is generated by applications executed by the respective communication apparatuses N.

For example, the communication apparatus N1 has a buffer B1t2 that buffers message M addressed to the communication apparatus N2 and a buffer B1t3 that buffers message M addressed to the communication apparatus N3.

Further, the communication apparatus N2 has a buffer B2t1 that buffers message M addressed to the communication apparatus N1 and a buffer B2t3 that buffers message M addressed to the communication apparatus N3.

The communication apparatus N3 has a buffer B3t1 that buffers message M addressed to the communication apparatus N1 and a buffer B3t2 that buffers message M addressed to the communication apparatus N2.

Hereinafter, an example of communication will be described where the communication apparatuses N1, N3 respectively transmit message M to the communication apparatus N2.

In FIG. 1, (1) for each generation of message M addressed to the communication apparatus N2, the communication apparatus N1 stores the generated message M to the buffer B1t2. Similarly, the communication apparatus N3 stores to the buffer B3t2, messages M addressed to the communication apparatus N2.

(2) In order to transmit message M stored in the buffer B1t2 to the communication apparatus N2, the communication apparatus N1 transmits to the communication apparatus N2, a request notification (request token) concerning a transmission right that permits transmission to the communication apparatus N2. The communication apparatus N1 waits to receive from the communication apparatus N2, a transmission right (permission token) permitting transmission to the communication apparatus N2. Here, the request token includes an identifier of the communication apparatus N1, which is the transmission source of message M, and the message volume stored in the buffer B1t2. The message volume stored in the buffer B1t2 is information that serves as an index of the pressure on the buffer B1t2.

(3) Similarly, to transmit message M stored in the buffer B3t2, the communication apparatus N3 transmits a request token to the communication apparatus N2. The communication apparatus N3 waits to receive a permission token from the communication apparatus N2. Here, the request token includes the identifier of the communication apparatus N3, which is the transmission source of message M, and the message volume stored in the buffer B3t2. The message volume stored in the buffer B3t2 is information that serves as an index of the pressure on the buffer B3t2.

(4) Having received a request token from the communication apparatuses N1, N3, respectively, the communication apparatus N2 refers to the message volume of the respective buffers B at the communication apparatuses N1, N3, indicated in the request tokens, and selects a transmission source (communication apparatus N1, N3) to which transmission right will be granted. In this example, the communication apparatus N2 judges that the communication apparatus N3 having a large message volume stored to the buffer B should be allowed to transmit message M before the buffer B becomes exhausted and grants the transmission right to the communication apparatus N3.

(5) Here, the communication apparatus N2 refers to the network throughput and determines the permissible data volume that the selected communication apparatus N3 is allowed to transmit of message M, such that congestion on the network is not caused. The communication apparatus N2 transmits to the selected communication apparatus N3, a permission token that includes the permissible data volume.

Thus, as depicted in FIG. 2, the communication apparatus N1 has not yet received a permission token, while on the other hand, the communication apparatus N3 has received a permission token that includes the permissible data volume.

In FIG. 2, (1) having received a permission token, the communication apparatus N3 collectively transmits to the communication apparatus N2, the permissible data volume of message M, from among message M stored in the buffer B3t2.

(2) On the other hand, since the communication apparatus N1 has not yet received a permission token, the communication apparatus N1 does not transmit message M stored in the buffer B1t2.

(3) Thus, the message volume on the network can be controlled and message M collisions can be avoided. Therefore, congestion caused by message M collisions can be suppressed and since congestion can be suppressed, increases in communication time caused by congestion can be avoided, enabling the communication phase of the network overall to be shortened.

Further, consequent to buffering, network throughput can be improved. The reception-side communication apparatus N, based on the message volume stored in the respective buffers B of the transmission-side communication apparatuses N, grants transmission rights and allows message M to be transmitted such that pressure is not put on the buffers B. Consequently, the network can be used efficiently and the throughput of the entire network can be improved.

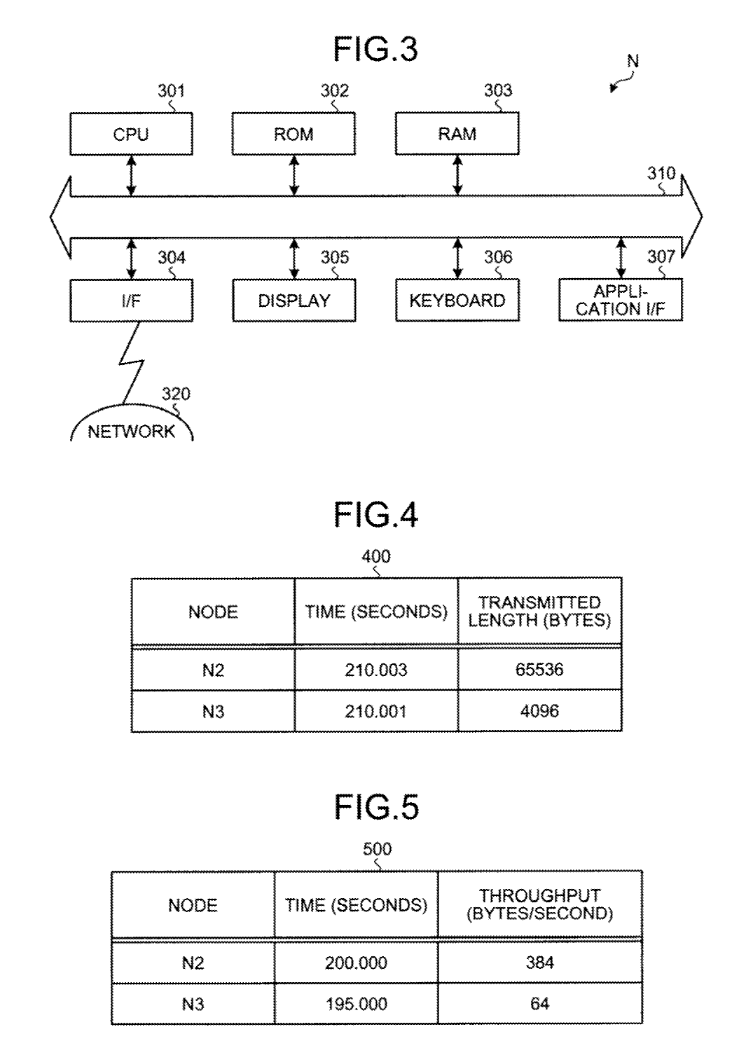

FIG. 3 is a block diagram of an example of a hardware configuration of the communication apparatus N according to an embodiment. As depicted in FIG. 3, the communication apparatus N includes a central processing unit (CPU) 301, a read-only memory (ROM) 302, a random access memory (RAM) 303, and interface (I/F) 304, a display 305, a keyboard 306, and an application I/F 307, respectively connected by a bus 310.

The CPU 301 governs overall control of the communication apparatus N. The ROM 302 stores therein programs such as a boot program. The RAM 303 is used as a work area of the CPU 301.

The RAM 303 is used as an area of the buffers B for each destination. The RAM 303 stores therein a transmitted-length log, a transmission request log, and a request token latency log. The RAM 303 further stores therein a transmitted-throughput log, a received-throughput log, issued permission token count information, and an issued permission token log. The RAM 303 additionally stores therein a communication counterpart list, a request token list, and a permission token list.

The I/F 304 is connected to a network 320 such as a local area network (LAN), a wide area network (WAN), and the Internet through a communication line, and via the network 320 is connected to other apparatuses.

The display 305 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 305. The keyboard 306 includes, for example, keys for inputting letters, numerals, and various instructions and performs the input of data. Alternatively, a touch-panel-type input pad or numeric keypad, etc. may be adopted.

The application I/F 307 controls the input and output of data from an application. For example, the application I/F 307 stores to the buffer B (the RAM 303) data generated by an application; passes to an application, data input from an external apparatus by the I/F 304; etc.

With reference to FIG. 4, the contents of the transmitted-length log stored in the RAM 303 depicted in FIG. 3 will be described.

FIG. 4 is a diagram of the transmitted-length log stored in the RAM 303 depicted in FIG. 3. A transmitted-length log 400 has a node field and transmitted-length field, respectively associated with a time field, forming a record for each transmission of message M.

The time field stores therein the time (seconds) when message M was transmitted. The node field stores therein the identifier of the communication apparatus N that is the destination of message M. The transmitted-length field stores therein the transmitted data volume (bytes) of message M.

With reference to FIG. 5, the contents of the transmission request log stored in the RAM 303 depicted in FIG. 3 will be described.

FIG. 5 is a diagram depicting the contents of the transmission request log stored in the RAM 303 depicted in FIG. 3. A transmission request log 500 has a node field and throughput field, respectively associated with a time field, forming a record for each request for message M transmission by an application.

The time field stores therein the time (seconds) when message M transmission was requested. The node field stores therein the identifier of the communication apparatus N that is the destination of message M and of which transmission of message M has been requested. The throughput field stores therein the message M data volume requested to be transmitted per unit time (bytes/second).

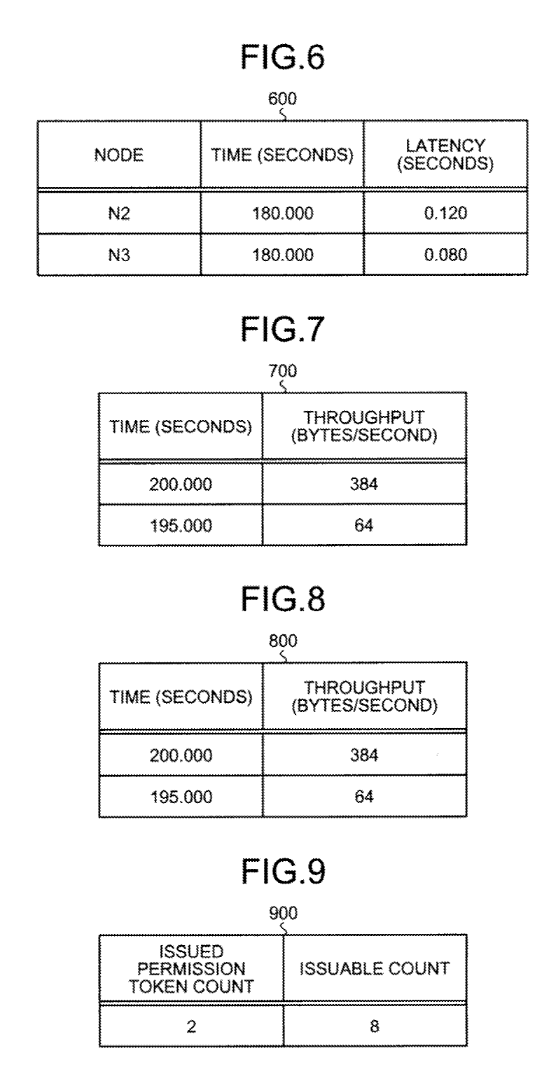

With reference to FIG. 6, the contents of the request token latency log stored in the RAM 303 depicted in FIG. 3 will be described.

FIG. 6 is a diagram depicting the contents of the request token latency log stored in the RAM 303 depicted in FIG. 3. A request token latency log 600 has a node field and a latency field, respectively associated with a time field. In the request token latency log 600, a record for each transmission of a request token is formed and updated at each reception of a permission token.

The time field stores therein the time (seconds) when a request token was transmitted. The node field stores therein the identifier of the communication apparatus N to which the request token was transmitted. The latency field stores therein the time from the transmission of the request token until the reception of a permission token.

With reference to FIG. 7, the contents of the transmitted-throughput log stored in the RAM 303 depicted in FIG. 3 will be described.

FIG. 7 is a diagram depicting the contents of the transmitted-throughput log stored in the RAM 303 depicted in FIG. 3. A transmitted-throughput log 700 has a throughput field associated with a time field, forming a record for each transmission of message M.

The time field stores therein the time (seconds) when message M was requested. The throughput field stores therein the message M data volume transmitted per unit time (bytes/second) and is calculated by, for example, the transmitted data volume/(the current transmission time−the previous transmission time).

With reference to FIG. 8, the contents of the received-throughput log stored in the RAM 303 depicted in FIG. 3 will be described.

FIG. 8 is a diagram depicting the contents of the received-throughput log stored in the RAM 303 depicted in FIG. 3. A received-throughput log 800 has a throughput field associated with a time field, forming a record for each reception of message M.

The time field stores therein the time (seconds) when transmission of message M was requested. The throughput field stores therein the message M data volume received per unit time (bytes/second) and can be calculated by, for example, the received data volume/(the current reception time−the previous reception time).

With reference to FIG. 9, the contents of the issued permission token count information stored in the RAM 303 depicted in FIG. 3 will be described.

FIG. 9 is a diagram depicting the contents of the issued permission token count information stored in the RAM 303 depicted in FIG. 3. Issued permission token count information 900 has an issued permission token count field associated respectively with an issuable count field, forming a record for each issuance of a permission token.

The issuable count field stores therein the number of issuable permission tokens. The issued permission token count field stores therein the number of issued permission tokens.

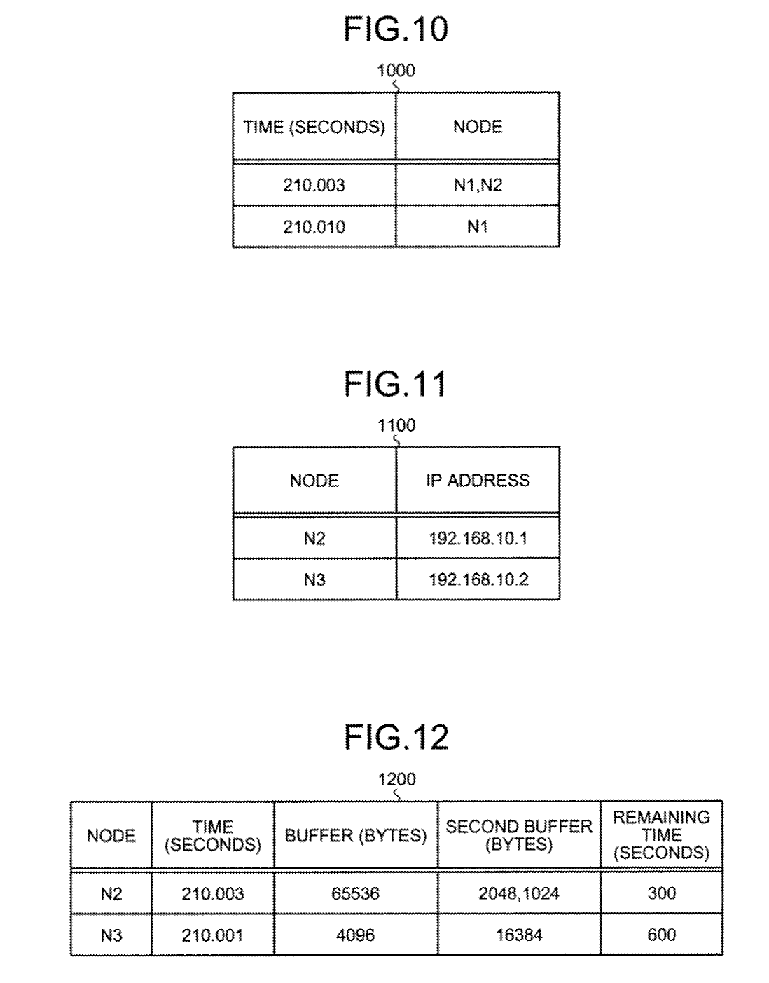

With reference to FIG. 10, the contents of the issued permission token log stored in the RAM 303 depicted in FIG. 3 will be described.

FIG. 10 is a diagram depicting the contents of the issued permission token log stored in the RAM 303 depicted in FIG. 3. An issued permission token log 1000 has a node field respectively associated with a time field, forming a record for each issuance of a permission token.

The time field stores therein the time (seconds) when a permission token was issued. The node field stores therein the identifier of the communication apparatus N to which the permission token was transmitted.

With reference to FIG. 11, the contents of the communication counterpart list stored in the RAM 303 depicted in FIG. 3 will be described.

FIG. 11 is a diagram depicting the contents of the communication counterpart list stored in the RAM 303 depicted in FIG. 3. A communication counterpart list 1100 has an IP address field respectively associated with a node field, forming a record for each communication counterpart node. The node field stores therein the identifier of the communication apparatus N that is a communication counterpart. The IP address field stores therein an IP address identifying the node.

With reference to FIG. 12, the contents of the request token list stored in the RAM 303 depicted in FIG. 3 will be described.

FIG. 12 is a diagram depicting the contents of the request token list stored in the RAM 303 depicted in FIG. 3. A request token list 1200 has a time field, a buffer field, a second buffer field, and a remaining time field, respectively associated with a node field, forming a record for each reception of a request token.

The node field stores therein the identifier of the communication apparatus N that transmitted the request token. The time field stores therein time (seconds) that the request token was received. The buffer field stores therein the data volume (bytes) stored by buffer B that is at the source of the request token and stores message M that is to be transmitted to the destination (device) of the request token.

The second buffer field stores therein the data volume (bytes) stored by another buffer B that is different from the buffer B that stores message M to be transmitted to the destination (device) of the request token. The remaining time field stores therein the time remaining until the transmission time limit of message M at the transmission source of the request token.

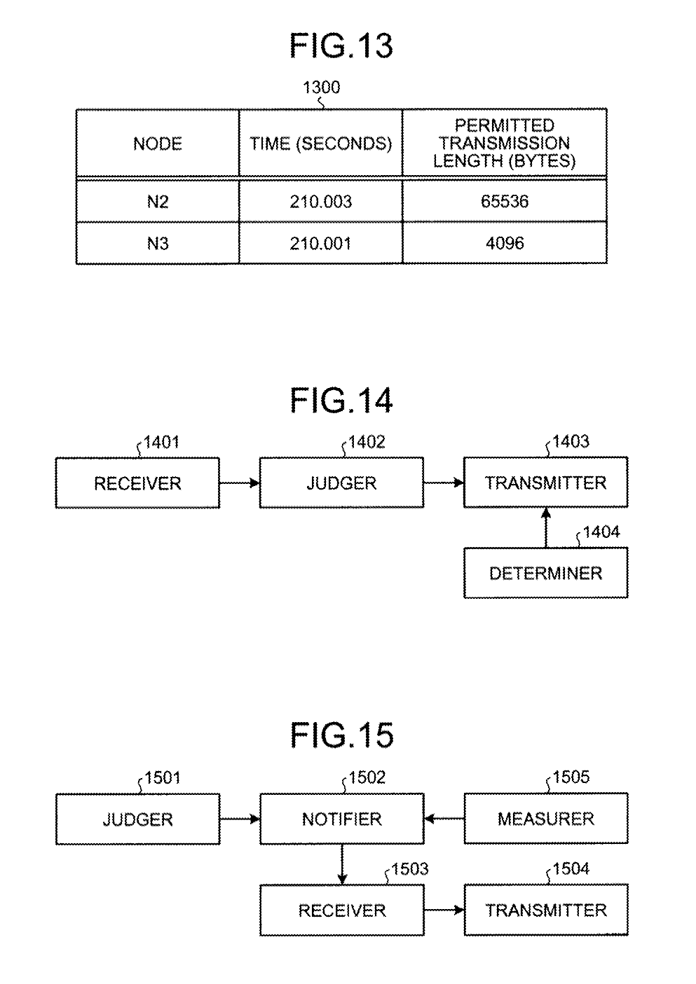

With reference to FIG. 13, the contents of the permission token list stored in the RAM 303 depicted in FIG. 3 will be described.

FIG. 13 is a diagram depicting the contents of the permission token list stored in the RAM 303 depicted in FIG. 3. A permission token list 1300 has a time field and a permitted transmission length field, respectively associated with a node field, forming a record for each reception of a permission token.

The node field stores therein the identifier of the communication apparatus N that transmitted the permission token. The time field stores therein the time (seconds) when the permission token was received. The permitted transmission length field stores therein the maximum data volume (bytes) that the transmission source of the permission token permits to be transmitted.

With reference to FIGS. 14 and 15, an example of a functional configuration of the communication apparatus N will be described. Here, for the sake of simplicity, the functions of the communication apparatus N as a receiver of message M and the functions of the communication apparatus N as the transmitter of message M will be described separately. However, the communication apparatus N may have the functions for both receiving and transmitting message M.

FIG. 14 is a block diagram depicting an example of a functional configuration of the communication apparatus N as a receiver of message M. The communication apparatus N includes a receiver 1401, a judger 1402, a transmitter 1403, and a determiner 1404. These functions (the receiver 1401 to the determiner 1404) forming a controller, for example are implemented by executing on the CPU 301, a program stored in a storage device such as the ROM 302 and RAM 303 depicted in FIG. 3, or by the I/F 304.

The receiver 1401 has a function of receiving from any given transmission source among multiple transmission sources, a request notification that concerns a transmission right permitting transmission to the communication apparatus N and includes information indicating the data volume of the data to be transmitted to the communication apparatus N. Here, the request notification is the request token described above. The transmission right is the permission token described above. The data to be transmitted is message M described above. The information identifying the data volume is information identifying the message volume (buffered volume for communication apparatus N) stored in buffer B (buffer B for communication apparatus N) storing message M that is addressed to the communication apparatus N.

The information indicating the data volume is, for example, an immediate value of the buffered volume (at the transmission source) for the communication apparatus N and may include the capacity of the buffer B (at the transmission source) for the communication apparatus N. Further, the information indicating the data volume may be a ratio of the capacity of the buffer B (at the transmission source) for the communication apparatus N and the buffered volume for the communication apparatus N. A received request token is stored to the request token list 1200 in the RAM 303.

For example, the receiver 1401 receives a request token that includes the identifier of the transmission source and the buffered volume (at the source) for the communication apparatus N, whereby the receiver 1401 is able to receive information that serves as an index for selecting a transmission source to which a transmission right will be granted.

The request notification received by the receiver 1401 may include information identifying the volume of data that is to be transmitted to another communication apparatus N that is different from the communication apparatus N that received the request notification. For example, the request token includes the message volume (buffered volume for another communication apparatus N) stored in a buffer B (buffer B for the other communication apparatus N) that is at the transmission source and stores therein message M that is addressed to the other communication apparatus that is different from the communication apparatus that received the request token. Thus, the receiver 1401 can receive information that serves as an index for selecting a transmission source to which a transmission right will be granted.

The request notification received by the receiver 1401 may include information related to a transmission time limit for the data that is at a transmission source and to be transmitted to the communication apparatus N. For example, the request token includes the time remaining until the transmission time limit for message M that is at the source and addressed to the communication apparatus N. Thus, the receiver 1401 can receive information that serves as an index for selecting a transmission source to which a transmission right will be granted.

The judger 1402 has a function of judging based on the request notification received by the receiver 1401, whether a transmission right is to be granted to a transmission source. Judgment results are stored to a storage area such at the RAM 303.

For example, the judger 1402 refers to the request notification for information identifying the data volume of the data to be transmitted to the communication apparatus N and information indicating the volume of data that is at another transmission source and is to be transmitted to the communication apparatus N. The judger 1402, based on the reference information, judges whether a transmission right is to be granted to the transmission source.

For instance, based on the buffered volume that is at each transmission source and for the communication apparatus N as indicated by the request tokens received from the transmission sources, the judger 1402 calculates the pressure on the buffers B that are at each transmission source and for the communication apparatus N. If a given transmission source is under more pressure than another transmission source, the judger 1402 judges that a transmission right is to be granted to the given transmission source. Consequently, a transmission right can be granted to a transmission source whose buffer B for the communication apparatus N is under relatively more pressure, enabling exhaustion of the buffer B to be prevented.

The judger 1402 refers to information identifying the data volume of the data to be transmitted to the communication apparatus N and information identifying the data volume of the data to be transmitted to another communication apparatus N. The judger 1402, based on the reference information in the request notification, judges whether a transmission right is to be granted to the transmission source.

For example, if the request token indicates that the buffered volume for another communication apparatus is greater than that for the communication apparatus N, the judger 1402 judges that a transmission right is not to be granted. Thus, at the transmission source, if message M should be preferentially transmitted to another communication apparatus N before transmission to the communication apparatus N that has received the request token, the judger 1402 does not grant a transmission right, enabling efficiency over the entire network to be facilitated.

If the number of transmission sources to which a transmission right has been granted is greater than or equal to a threshold, the judger 1402 judges that no transmission right is to be granted to any transmission source. For instance, when the number of issued permission tokens is the number of permission tokens allowed to be issued, the judger 1402 judges that no transmission right is to be granted. Consequently, network throughput is managed and congestion is suppressed.

Based on the information related to the transmission time limit included in the request notification and information related to the transmission time limit of data that is to be transmitted to the communication apparatus N and that is at another transmission source, the judger 1402 judges whether a transmission right is to be granted to the given transmission source.

For instance, for each transmission source, the judger 1402 refers to the time remaining until the transmission time limit of message M addressed to the communication apparatus N, as indicated in the request tokens. Based on the time remaining for each transmission source, if the time remaining for a given transmission source is less than that for other transmission sources, the judger 1402 judges that a transmission right is to be granted to the given transmission source. Thus, a transmission right can be granted to a transmission source whose transmission time limit is closer, thereby enabling transmission of message M before the transmission time limit.

The transmitter 1403 has a function of transmitting a transmission right to a transmission source that has been granted a transmission right by the judger 1402. Here, the transmission right is the permission token described above. For example, the transmitter 1403 transmits to a transmission source granted a transmission right, a permission token that includes the identifier of the communication apparatus N. Thus, the transmitter 1403 transmits a permission token to the transmission source, thereby enabling the transmission source to the begin transmission of message M.

The transmitter 1403 has function of transmitting to a transmission source that has been granted a transmission right by the judger 1402, a transmission right that includes a permissible data volume that is determined by the determiner 1404. The permissible data volume is the maximum message volume that a transmission source to which a transmission right has been granted can transmit and is determined by the determiner 1404 (described hereinafter) such that network congestion does not occur. For example, the transmitter 1403 transmits a permission token that includes an identifier identifying the communication apparatus N, and the permissible data volume determined by the determiner 1404 described hereinafter. Thus, network congestion can be suppressed since a permissible data volume that has been determined with consideration of network throughput is provided to a transmission source.

The determiner 1404 has a function of determining based on the request notification received by the receiver 1401, the permissible data volume of the data to be transmitted by a transmission source that has been granted a transmission right by the judger 1402.

For example, based on the network throughput, and the buffered volume for the communication apparatus N indicated in the request token, the determiner 1404 determines the maximum message volume that a transmission source can transmit, to the extent that network congestion does not occur. The determined permissible data volume is stored to storage area such as the RAM 303. Thus, the determiner 1404 is able to determine a permissible data volume to suppress network congestion.

FIG. 15 is a block diagram depicting an example of a functional configuration of the communication apparatus N as a transmitter of message M. The communication apparatus N includes a judger 1501, a notifier 1502, a receiver 1503, a transmitter 1504, and a measurer 1505. These functions (the judger 1501 to the measurer 1505) forming a controller, for example, are implemented by executing on the CPU 301, a program stored in a storage device such as the ROM 302 and the RAM 303 depicted in FIG. 3, or by the I/F 304.

The judger 1501 has a function of judging based on the volume of data to be transmitted to a destination among multiple destinations, whether to request a transmission destination for a transmission right permitting transmission to the destination from the transmission source. Here, the transmission right is the permission token described above. The data to be transmitted is message M described above. The volume of data to be transmitted to a destination is the message volume in a buffer B that stores message M addressed to the communication address N that is the destination.

For example, if the volume of data to be transmitted to a destination is greater than or equal to a threshold, the judger 1501 judges that a transmission right is to be requested of the destination. Here, the threshold is a target buffering volume described hereinafter and a value that serves as an index for transmitting message M before the buffer B becomes exhausted. For example, the threshold is “the buffer B capacity×a safety coefficient (e.g., 0.6)”. Further, for example, the threshold is “the buffer B capacity−the average throughput×the average request token latency”. Consequently, the judger 1501 is able to trigger the transmission of a request token before the buffer B becomes exhausted.

The notifier 1502 has a function of notifying a destination of a request notification that includes information identifying the data volume of the data to be transmitted to the destination, when the judger 1501 has judged that a transmission right is to be requested. Here, the request notification is the request token described above. For example, the notifier 1502 transmits a request token to a destination of which a transmission right is to be requested. Thus, a request token that triggers the communication apparatus N to grant a transmission right can be transmitted to the destination of message M.

The notifier 1502 has a function of notifying a destination of a request notification when the elapsed time measured by the measurer 1505 is greater than or equal to a threshold that is based on the transmission time limit of the data to be transmitted to the destination. Here, the transmission time limit is the maximum (the maximum allowed latency) message M latency (the time from the transmission of a request until transmission) that an application can allow. The threshold based on a transmission time limit is a deadline described hereinafter and a value that serves as an index for transmitting message M before the transmission time limit. For example, the threshold based on a transmission time limit is the maximum allowed latency×safety coefficient (e.g., 0.6). Further, for example the threshold based on a transmission time limit is “the maximum allowed latency−the average request token latency”.

For instance, the notifier 1502 provides a request token when the time elapsing since the generation of message M and measured by the measurer 1505 described hereinafter reaches or exceeds the threshold that is based on a transmission time limit. Thus, the judger 1501 can transmit to the destination of message M, a request token that triggers the communication apparatus N to grant a transmission right before transmission time limit elapses.

The request notification may further include information related to the transmission time limit of the data to be transmitted to a destination. The information related to a transmission time limit is, for example, the time that has elapsed since the generation of message M. The information related to a transmission time limit may further be, for example, the time remaining until the transmission time limit. Thus, information related to a transmission time limit and serving as an index for judging whether a transmission right is to be granted at the destination can be provided to the destination.

The request notification may include information indicating the volume of data to be transmitted to another destination that is different from a given destination. Here, the information indicating the volume of data to be transmitted to another destination is, for example, the message volume in the buffer B that stores message M addressed to another destination. Thus, the message volume that is in the buffer B storing message M addressed to another destination and that serves as an index for judging whether a transmission right is to be granted at the destination can be provided to the destination.

The receiver 1503 has a function of receiving a transmission right from a destination consequent to the notifier 1502 providing the request notification. Here, the transmission right is the permission token described above. For example, the receiver 1503 receives from the destination to which a request token was provided, a permission token that includes the identifier of the destination. The transmission right may further include a permissible data volume for the data to be transmitted. Thus, the receiver 1503 can obtain the transmission right and the maximum message volume for the data to be transmitted. The received permission token is stored to the permission token list 1300 in the RAM 303.

The transmitter 1504 has a function of transmitting to a destination, the data that is to be transmitted to the destination, when a transmission right has been received by the receiver 1503. For example, if a permission token has been received, the transmitter 1504 transmits to the destination, message M stored in the buffer. Thus, the transmitter 1504 is can avoid collisions of message M on the network since message M is transmitted after a permission token is received.

The transmitter 1504 has a function of transmitting to a destination, data of the permissible data volume or less, among the data to be transmitted to the destination. For example, if a permission token has been received, the transmitter 1504 extracts the permissible data volume or less of message M from the buffer, and transmits the extracted message M to the destination. Thus, the transmitter 1504 can avoid collisions of message M on the network and suppress congestion since the permissible data volume or less of message M is transmitted after a permission token is received.

The measurer 1505 has a function of measuring the time that elapses since the generation of data to be transmitted to a destination. For example, the measurer 1505 begins measuring when message M is generated by an application and measures the time that elapses. Thus, the measurer 1505 can know the time remaining until the transmission time limit of message M.

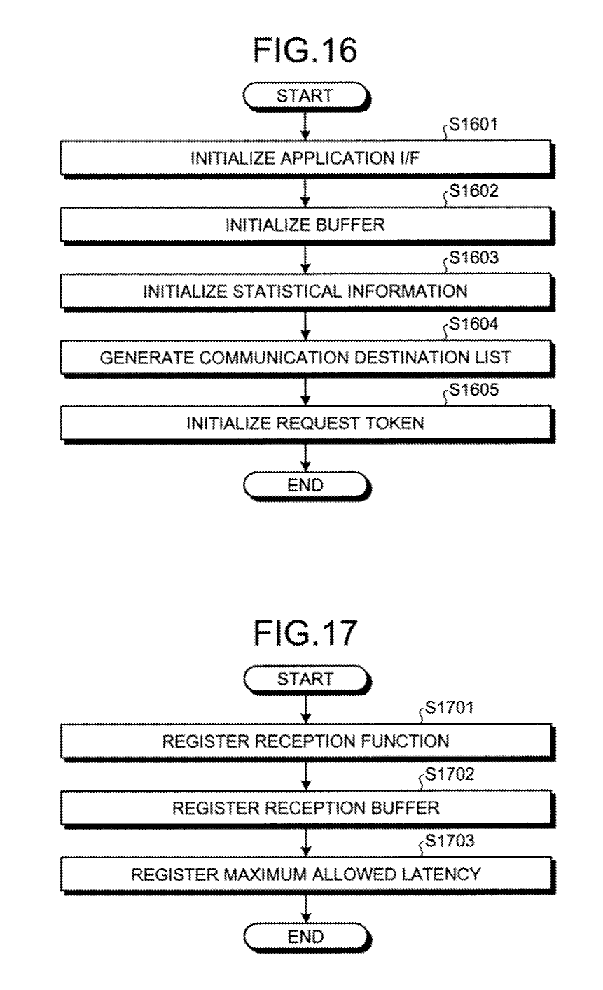

With reference to FIGS. 16 and 17, processing performed by the communication apparatus N as preparation for communication will be described.

With reference to FIG. 16, initialization processing performed by the communication apparatus N before communication will be described.

FIG. 16 is a flowchart of the initialization processing. The CPU 301 initializes the application I/F 307 (step S1601). During the initialization of the application I/F 307, application-use registration processing described herein is performed. The CPU 301 initializes the buffer B (step S1602). The CPU 301 initializes statistical information (the transmitted-length log 400, the transmitted-throughput log 700, and the received-throughput log 800) (step S1603).

The CPU 301 generates the communication counterpart list 1100 (step S1604). The CPU 301 initializes a request token (step S1605), and ends the initialization processing. Thus, the communication apparatus N becomes able to begin communication.

With reference to FIG. 17, application-use registration processing performed by the communication apparatus N to provide the received message M to an application will be described.

FIG. 17 is a flowchart of the application-use registration processing. The CPU 301 registers a reception function (step S1701). The CPU 301 registers a reception buffer (step S1702).

The CPU 301 registers the maximum allowed latency (step S1703), and ends the application-use registration processing. Consequently, the communication apparatus N is able to provide the received message M to an application.

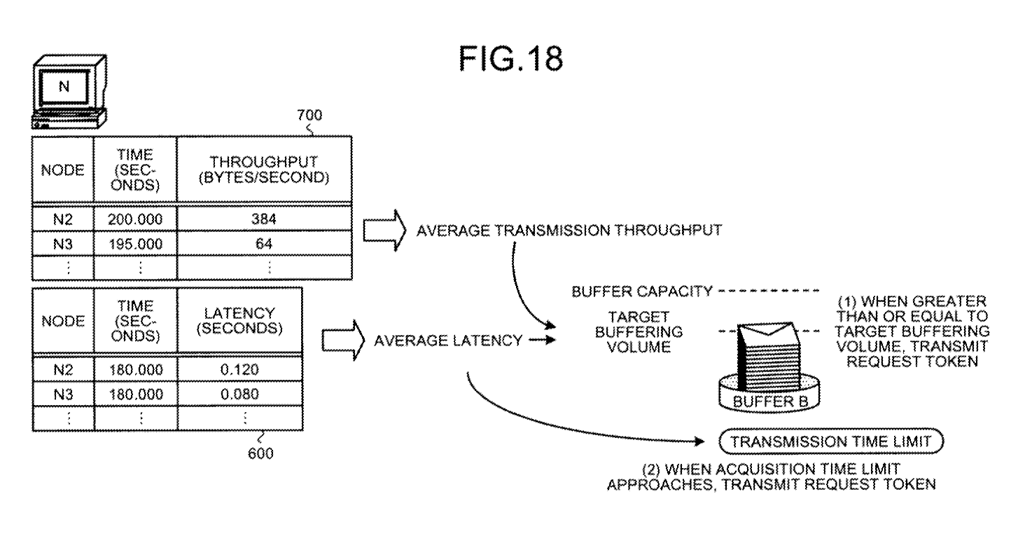

With reference to FIGS. 18 to 20, processes of the communication apparatus N when transmitting message M will be described, e.g., processes of the communication apparatuses N1, N3 depicted in FIG. 1.

With reference to FIG. 18, the contents of request token transmission by the communication apparatus N when transmitting message M will be described.

FIG. 18 is a diagram depicting the contents of request token transmission. The communication apparatus N, such that the buffer B does not become exhausted, calculates the target buffering volume that serves as an index for transmitting message M before the buffer B becomes exhausted.

Here, the communication apparatus N calculates the average transmitted throughput using the transmitted-throughput log 700. Further, the communication apparatus N calculates the average request token latency using the request token latency log 600. The communication apparatus N calculates, for example, “the buffer B capacity−the average transmitted throughput×the average request token latency” as the target buffering volume.

However, the communication apparatus N may refer to the transmitted-length log 400 and the transmission request log 500 to further adjust the target buffering volume. For example, the communication apparatus N refers to the transmitted-length log 400 and if message M has been frequently transmitted in small volumes in the past, may adjust the target buffering volume to be lower so that request token transmission is performed more frequently. Further, the communication apparatus N may refer to the transmission request log 500 and if the application has requested the transmission of a large volume of message M in the past, may adjust the target buffering volume to be lower.

(1) The communication apparatus N transmits a request token when the buffered volume of the buffer N is greater than the calculated target buffering volume. Consequently, the communication apparatus N can trigger the transmission of a request token before the buffer B is exhausted.

The communication apparatus N calculates a deadline that serves as an index for transmitting message M before the transmission time limit. The transmission time limit is the maximum (the maximum allowed latency) message M latency (the time from the transmission of a request until the transmission of data) that an application can allow. The communication apparatus N calculates, for example “the maximum allowed latency−the average request token latency” as the deadline.

(2) The communication apparatus N measures the time that elapses since the generation of message M and if the elapsed time passes the calculated deadline, transmits a request token. Consequently, before the transmission time limit passes, the communication apparatus N can transmit to the destination of message M, a request token that triggers the destination communication apparatus N to grant a transmission right.

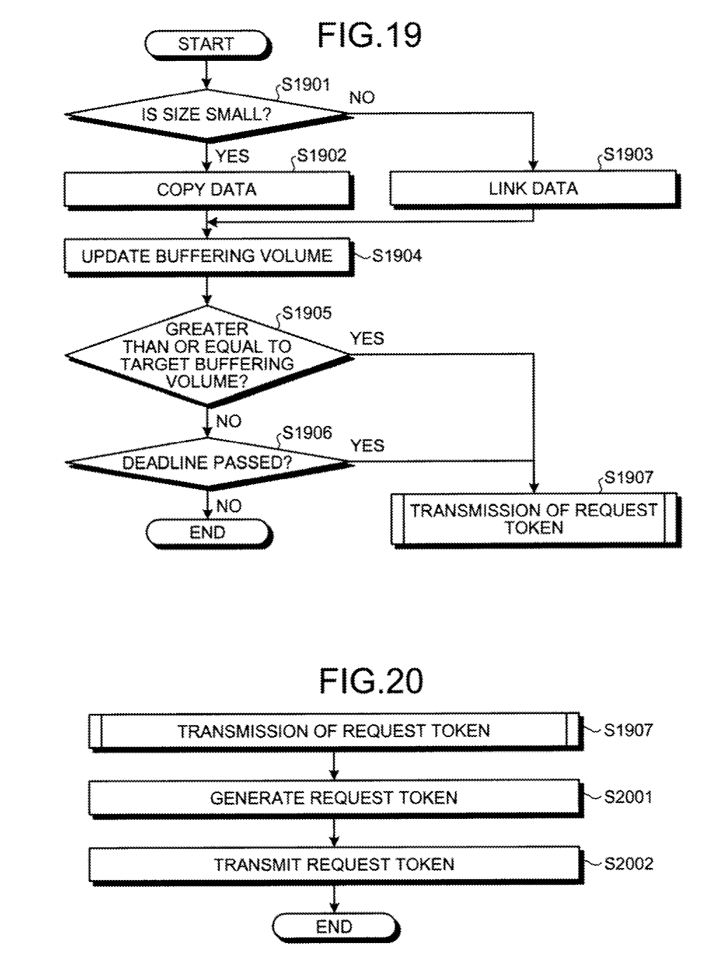

With reference to FIG. 19, buffer management processing by the communication apparatus N to transmit a request token as depicted in FIG. 18 will be described.

FIG. 19 is a flowchart of the buffer management processing. The CPU 301 judges whether data is of a small size (step S1901). If the size is small (step S1901: YES), the CPU 301 copies the data to buffer B (step S1902), and transitions to step S1904.

On the other hand, if the size is large (step S1901: NO), the CPU 301 links the data to buffer B (step S1903), and transitions to step S1904.

The CPU 301 updates the buffered volume (step S1904), and judges whether the buffered volume is at least the target buffering volume (step S1905). If the buffered volume is greater than or equal to the target buffering volume (step S1905: YES), the CPU 301 transitions to request token transmission processing (step S1907).

On the other hand, if the buffered volume is less than target buffering volume (step S1905: NO), the CPU 301 judges whether the time that has elapsed since the transmission request has passed the deadline (step S1906). If the time has passed the deadline (step S1906: YES), the CPU 301 transitions to the request token transmission processing (step S1907).

On the other hand if the time has not passed the deadline (step S1906: NO), the CPU 301 ends the buffer management processing. Consequently, request token transmission can be triggered before the capacity of the buffer B falls under pressure.

With reference to FIG. 20, the request token transmission processing depicted in FIG. 19 will be described. The request token includes an identifier identifying the transmission source, and the buffered volume for the communication apparatus N that is the destination of the request token.

FIG. 20 is a flowchart of the request token transmission processing. The CPU 301 generates a request token (step S2001). The CPU 301 transmits the generated request token (step S2002), and ends the request token transmission processing. Consequently, the communication apparatus N can transmit a request token.

Here, the generated request token includes, for example, the identifier of the source communication apparatus N and the message volume of the buffer B that stores therein message M that is addressed to the communication apparatus N that is the destination of the request token. Further, the request token may include the message volume of another buffer B that is different from the buffer B that stores therein message M that is addressed to the destination of the request token. The request token may further include information (e.g., the time remaining until the transmission time limit) related to the transmission time limit of message M that is addressed to the communication apparatus N that is the destination of the request token.

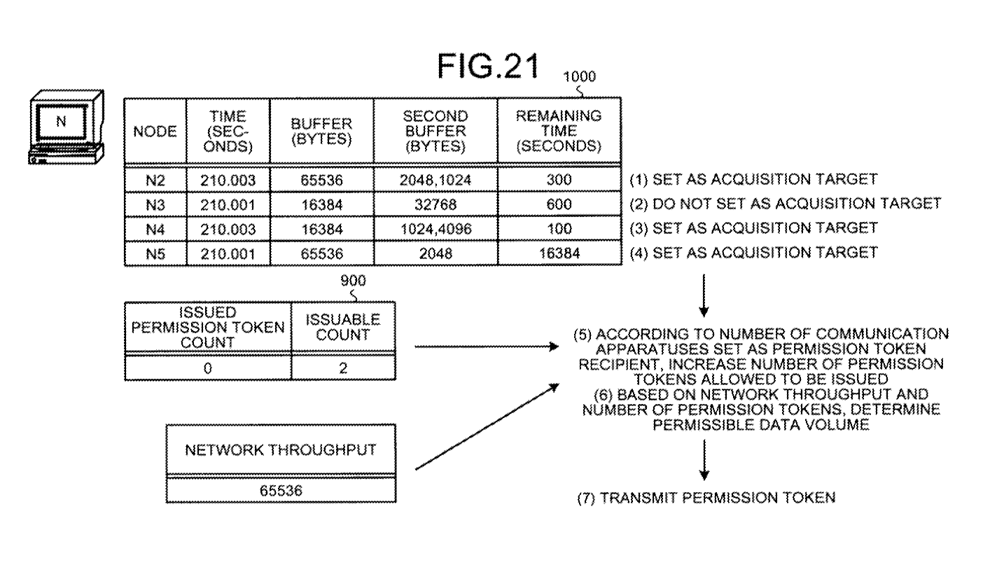

With reference to FIGS. 21 to 23, processes of the communication apparatus N when receiving message M will be described.

With reference to FIG. 21, the contents of permission token transmission by the communication apparatus N that has received a request token will be described. The communication apparatus N generates the request token list 1200 using the received request token.

FIG. 21 is a diagram of permission token transmission. Here, the communication apparatus refers to each record in the request token list 1200 and determines communication apparatuses N that are to be permission token recipients.

(1) For example, the communication apparatus N sets, as a permission token recipient, the communication apparatus N2, which has a large message volume in the buffer B for the communication apparatus N

(2) Further, for example, the communication apparatus N does not set, as a permission token recipient, the communication apparatus N3, which has a buffer B that is under pressure and different from the buffer B for the communication apparatus N.

(3) Further, for example, the communication apparatus N sets, as a permission token recipient, a communication apparatus N4, which has little time remaining until the transmission time limit.

(4) Further, for example, the communication apparatus N sets, as a permission token recipient, a communication apparatus N5, which has a large message volume in the buffer for the communication apparatus N.

(5) The communication apparatus N, according to the number of communication apparatuses N set as a permission token recipient, increases the number of permission tokens allowed to be issued. The communication apparatus N determines, within the number of permission tokens allowed to be issued, the number of permission tokens to be transmitted to the communication apparatuses N set as a permission token recipient.

In this example, the number of permission tokens allowed to be issued is dynamically increased according to the number of communication apparatuses N set as a permission token recipient, however, the number of permission tokens allowed to be issued may be a fixed value. In this case, the communication apparatus N determines the number of permission tokens that are to be transmitted such that the number is within the fixed value.

(6) The communication apparatus N, such that network congestion does not occur and based on the determined number of permission tokens to be transmitted and the network throughput, determines the permissible data volume that can be transmitted by the communication apparatus N that is the transmission source. For example, when the number of permission tokens to be transmitted is high, the permissible data volume transmitted by each communication apparatus N is reduced and can be calculated by, for example, the network throughput/the number of permission tokens to be transmitted.

(7) The communication apparatus N transmits to the communication apparatuses N set as a permission token recipient, a permission token that includes the determined permissible data volume. Thus, message M can be transmitted by multiple communication apparatuses N to an extent that network congestion does not occur.

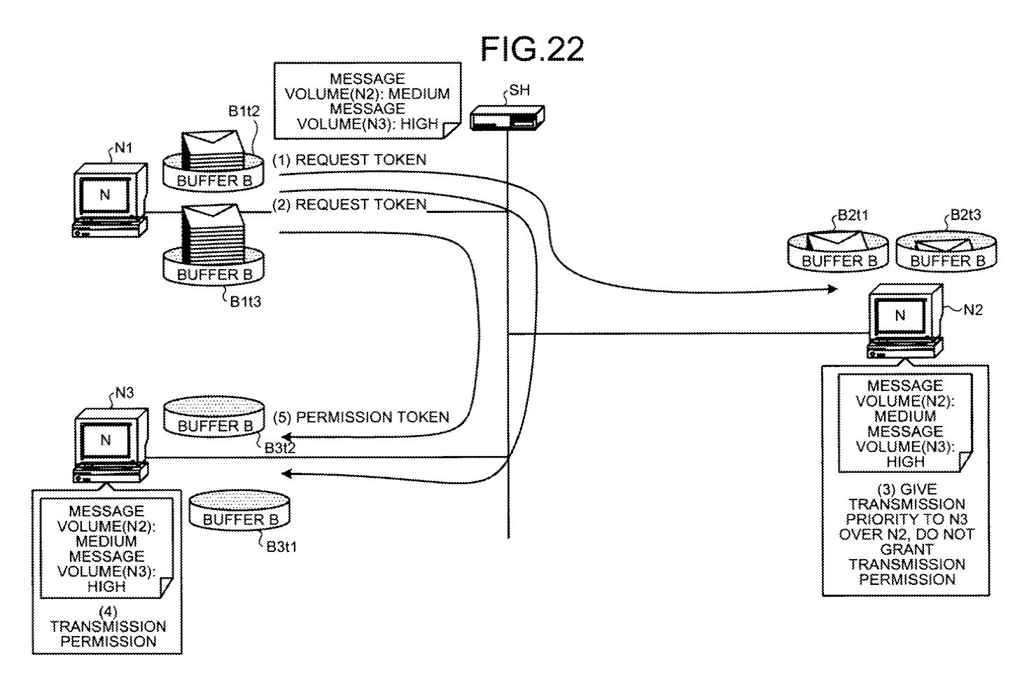

With reference to FIG. 22, permission token transmission performed by a communication apparatus N that has received a request token, which includes the buffered volume for another destination will be described, e.g., the contents of the processing depicted at (2) in FIG. 21 will be described.

FIG. 22 is a diagram of permission token transmission that is based on a request token that includes the buffered volume for another destination. Here, the communication system depicted in FIG. 22 is a system that similar to FIG. 1, is of multiple communication apparatuses N (in the example depicted in FIG. 22, the 3 communication apparatuses N1 to N3) connected via a network. The communication system communicates message M and includes a switching hub SH, which is a device that performs interrupts on the network. The communication apparatuses N have buffers B as depicted in FIG. 1.

Here, an example will be described where the communication apparatus N1 transmits message M respectively to the communication apparatuses N2, N3 and communication by the communication apparatus N will be described.

In FIG. 22, (1) since message M addressed to the communication apparatus N2 is stored in the buffer B1t2, the communication apparatus N1 transmits a request token to the communication apparatus N2. The communication apparatus N1 awaits the reception of a permission token from the communication apparatus N2.

(2) Since message M addressed to the communication apparatus N3 is stored in the buffer B1t3, the communication apparatus N1 further transmits a request token to the communication apparatus N3. The communication apparatus N1 awaits the reception of a permission token from the communication apparatus N3. Here, the respective request tokens include the identifier of the communication apparatus N1 that is the transmission source of message M, the message volume in the buffer B1t2, and the message volume in the buffer B1t3. The message volume is information that serves as an index of the pressure on the respective buffers B.

(3) Having received the request token from the communication apparatus N1, the communication apparatus N2 refers to the message volume in the buffer B1t2 and the message volume in the buffer B1t3 indicated in the request token, and judges whether a transmission right is to be granted to the communication apparatus N1.

In this example, the message volume in the buffer B1t3 is assumed to be greater than the message volume in the buffer B1t2; and therefore, the communication apparatus N2 judges that at the communication apparatus N1, the transmission of message M stored in the buffer B1t3 for the communication apparatus N3 should be given priority over the transmission of message M stored in the buffer B1t2 for the communication apparatus N2. The communication apparatus N2 does not grant a transmission right to the communication apparatus N1.

(4) Meanwhile, having received the request token from the communication apparatus N1, the communication apparatus N3 refers to the message volume in the buffer B1t2 and the message volume in the buffer B1t3 indicated in the request token. The communication apparatus N3, based on the reference message volumes, judges whether a transmission right is to be granted to the communication apparatus N1.

(5) In this example, the message volume in the buffer B1t3 is assumed to be greater than the message volume in buffer B1t2; and therefore, the communication apparatus N3 judges that at the communication apparatus N1, the transmission of message M in the buffer B1t3 for the communication apparatus N3 should be given priority over the transmission of message M in the buffer B1t2 for the communication apparatus N2. The communication apparatus N3 judges that message M should be transmitted by the communication apparatus N1 before the buffer B1t3 for the communication apparatus N3 becomes exhausted, and grants a transmission right to the communication apparatus N1.

In this manner, since the granting of a transmission right is determined based on the pressure of the buffers at a transmission source, the efficiency of the network overall and not the efficiency between communication apparatuses N, one-on-one, can be facilitated. Consequently, at the transmission-side communication apparatus N, the transmission of message M stored in a buffer B that is under relatively more pressure can be given priority and exhaustion of the capacity of the buffer B can be avoided.

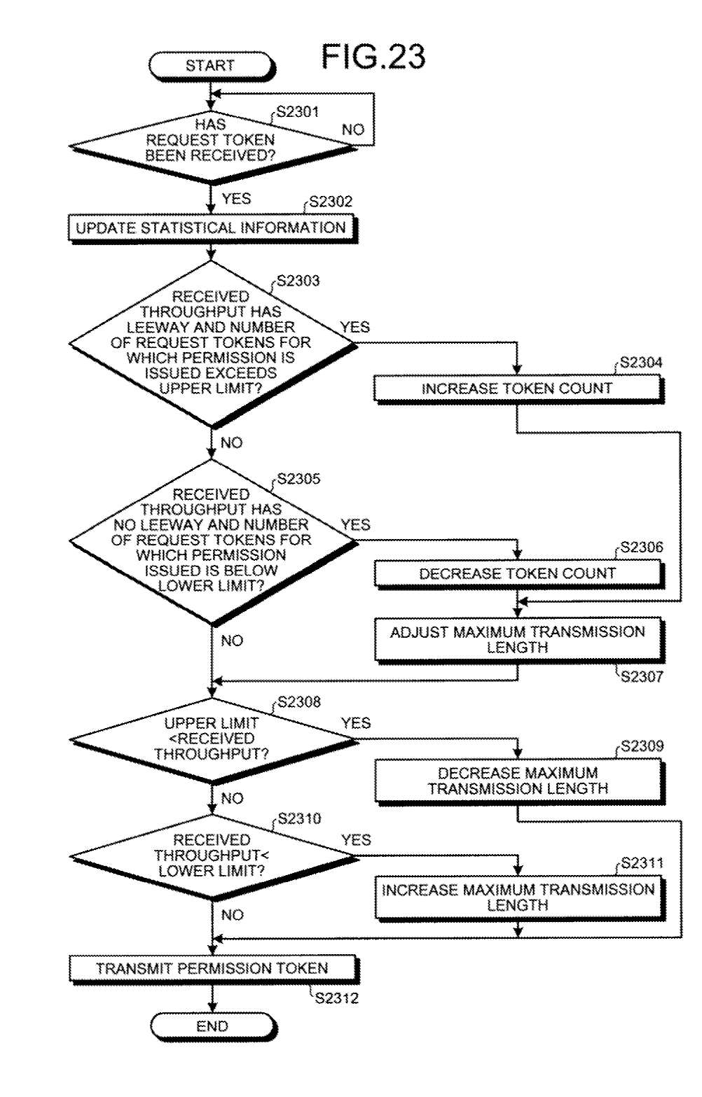

With reference to FIG. 23, permission token transmission processing performed by a communication apparatus N that has received a request token will be described and is, for example, the processing performed by the communication apparatus N2 depicted in FIG. 1.

FIG. 23 is a flowchart of the permission token transmission processing. The CPU 301 judges whether a request token has been received (step S2301). If a request token has not been received (step S2301: NO), the CPU 301 returns to step S2301 and awaits reception of a request token.

On the other hand, if a request token has been received (step S2301: YES), the CPU 301 updates statistical information (step S2302). The CPU 301 judges if the received throughput has some leeway and the number of request tokens for which a permission token is issued exceeds an upper limit (step S2303). The received throughput having some leeway means, for example, that the received throughput is less than the maximum physical throughput that the communication apparatus N can receive. If the received throughput has some leeway and the upper limit is exceeded (step S2303: YES), the CPU 301 increases the number of permission tokens allowed to be issued (step S2304), and transitions to step S2307.

On the other hand, if the received throughput has no leeway or if the upper limit is not exceeded (step S2303: NO), the CPU 301 judges if the received throughput has no leeway and the number of request tokens for which a permission token is issued is below a lower limit (step S2305). If the received throughput has no leeway and the number is below the lower limit (step S2305: YES), the CPU 301 decreases the number of permission tokens allowed to be issued (step S2306), and transitions to step S2307.

At step S2307, the CPU 301 adjusts the permissible data volume according to the number of permission tokens that can be issued (step S2307), and transitions to step S2308. Meanwhile, if the received throughput has some leeway or if the number is not below the lower limit (step S2305: NO), the CPU 301 transitions to step S2308.

The CPU 301 judges whether the received throughput is greater than an upper limit (step S2308). If the received throughput is greater than the upper limit (step S2308: YES), the CPU 301 decreases the permissible data volume (step S2309), and transitions to step S2312.

On the other hand, if the received throughput is less than or equal to the upper limit (step S2308: NO), the CPU 301 judges whether the received throughput is less than a lower limit (step S2310). If the received throughput is less than the lower limit (step S2310: YES), the CPU 301 increases the permissible data volume (step S2311), and transitions to step S2312.

Meanwhile, if the received throughput is greater than or equal to the lower limit (step S2310: NO), the CPU 301 transitions to step S2312. At step S2312, the CPU 301 transmits a permission token that includes the permissible data volume (step S2312), and ends the permission token transmission processing. Here, the upper limit and lower limit values are values set by the user of the communication apparatus N.

Thus, the communication apparatus N can transmit a permission token. Further, according to the number of request tokens, the communication apparatus N can change the number of permission tokens to be transmitted. The communication apparatus N can further calculate the permissible data volume transmitted by the transmission source.

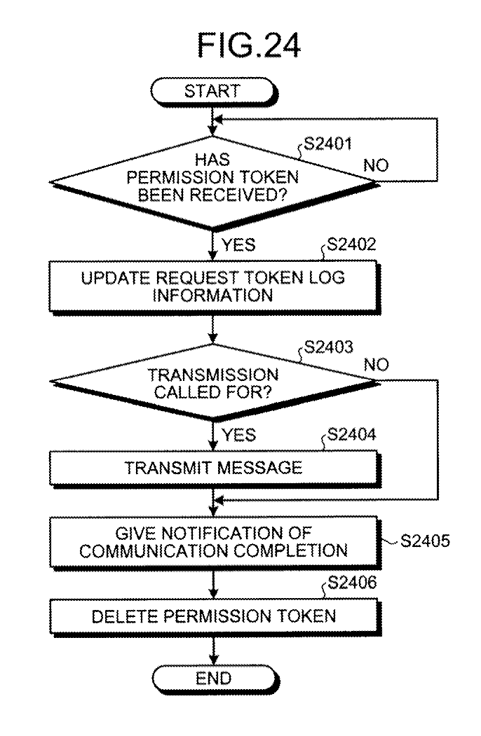

With reference to FIG. 24, message transmission processing performed by a communication apparatus N that has received a permission token, e.g., the processing performed by the communication apparatus N3 depicted in FIG. 1 will be described.

FIG. 24 is a flowchart of the message transmission processing. The CPU 301 judges whether a permission token has been received (step S2401). If a permission token has not been received (step S2401: NO), the CPU 301 returns to step S2401 and awaits reception of a permission token.

On the other hand, if a permission token has been received (step S2401: YES), the CPU 301 updates request token log information (the transmitted-length log 400, the request token latency log 600, and the permission token list 1300) (step S2402). The CPU 301 judges whether transmission is called for (step S2403). If transmission is not called for (step S2403: NO), the CPU 301 transitions to step S2405.

If transmission is called for (step S2403: YES), the CPU 301 transmits message M (step S2404). However, if the permissible data volume is indicated in the permission token, the CPU 301 transmits the permissible data volume or less of message M.

The CPU 301 transmits communication completion notification (step S2405), deletes the permission token (step S2406), and ends the message transmission processing. Consequently, the communication apparatus N can transmit message M after waiting for the reception of a permission token, thereby enabling message M collisions on the network to be avoided.

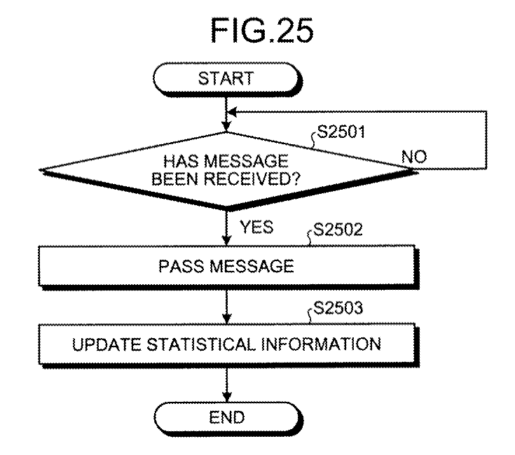

With reference to FIG. 25, message reception processing performed by a communication apparatus N that has received message M, e.g., the processing performed by the communication apparatus N depicted in FIG. 1, will be described.

FIG. 25 is a flowchart of the message reception processing. The CPU 301 judges whether message M has been received (step S2501). If message M has not been received (step S2501: NO), the CPU 301 returns to step S2501, and awaits reception of message M.

On the other hand, if message M has been received (step S2501: YES), the CPU 301 passes message M to an application (step S2502). The CPU 301 updates statistical information (step S2503), and ends the message reception processing. Consequently, the communication apparatus N can be caused to pass message M to an application and perform processing.

As described, according to the communication apparatus, the communication method, and the computer product, based on the buffered volumes at each transmission source as indicated by request tokens received from the transmission sources, a transmission right is granted to a transmission source whose buffer B is under relatively more pressure. Further, the transmission source does not transmit message M until a transmission right is received.

Thus, by not allowing the buffers B at each transmission source to become exhausted and by managing the message volume transmitted on the network, collisions of message M are avoided and congestion can be suppressed. Since congestion can be suppressed, increases in communication time, which are caused by congestion, can be avoided and the communication phase of the network overall can be shortened.

The request token includes the buffered volume of each buffer at a transmission source, whereby message M in the buffer B under the most pressure is given priority for transmission, thereby enabling the buffer B to be prevented from becoming exhausted. Further, since a transmission right is granted based on the buffered volume in each buffer B at a transmission source, efficiency over the entire network, not just the efficiency between communication apparatuses one-to-one, can be facilitated.

The communication apparatus N can set the number of transmission sources that are granted a transmission right at the same time to be less than or equal to a threshold, manage the message volume on the network, avoid collisions of message M, and suppress congestion.

Since information related to the transmission time limit of message M at the transmission source is included in the request token, a transmission source whose transmission time limit is approaching is preferentially granted a transmission right, thereby enabling message M to be transmitted by the transmission source before the transmission time limit.

The communication apparatus N determines the upper limit of the message volume that is to be transmitted by a transmission source and the transmission source transmits message M of a volume that is less than or equal to the determined upper limit. Thus, the message volume transmitted on the network can be managed, collisions of message M can be avoided, and congestion can be suppressed.

The transmission source, based on the buffered volume of the buffer B, judges whether to transmit a request token. Thus, before the buffer B becomes exhausted, a request token can be transmitted and a transmission right received.

The transmission source, based on the transmission time limit of message M, judges whether to transmit a request token. Thus, before the transmission time limit, a request token is transmitted and message M can be transmitted before the transmission time limit.

Here, in processing fields that use distributed parallel computers such as clusters, communication counterparts are determined depending on calculation results in the course of processing and there are difficult types of processes that preliminarily predict which communication apparatus will be a communication counterpart, such as MapReduce shuffle, Key-Value Storage systems, and Distributed Complex Event Processing.

By algorithms as well as logical and temporal arrangement of communication apparatuses with respect to such difficult processing for preliminarily predicting communication counterparts, a problem arises in that message communication scheduling, the prevention of collisions, and suppression of congestion cannot be performed. However, the communication apparatus, communication method, and computer product according to the present embodiment are applicable to such difficult processing for preliminarily predicting communication counterparts and, can prevent collisions of message M and suppress congestion.

If message M collision occurs, among technologies suppressing congestion, there is technology that controls Transmission Control Protocol/Internet Protocol (TCP/IP) flow and that prevents Ethernet (registered trade name) collision. Nonetheless, with such technology controlling TCP/IP flow and/or preventing Ethernet (registered trade name) packet collision, a problem arises in that from message M collision until congestion is suppressed, packet loss occurs on the network. A further problem arises in that overhead occurs for control switching by an Ethernet (registered trade name) switch. Consequent to an excess of received data, at the communication apparatus on the reception side, problems of cache miss hits and insufficient memory occur. However, the communication apparatus, communication method, and computer product according to the present embodiment can prevent message M collisions and suppress congestion without the problems of cache miss hits and insufficient memory that occur with technology that controls Transmission Control Protocol/Internet Protocol (TCP/IP) flow and that prevents Ethernet (registered trade name) collision.

The communication method described in the present embodiment may be implemented by executing a prepared program on a computer such as a personal computer and a workstation. The program is stored on a computer-readable medium such as a hard disk, a flexible disk, a CD-ROM, an MO, and a DVD, read out from the recording medium, and executed by the computer. The program may be distributed through a network such as the Internet. However, the computer-readable medium does not include a transitory medium such as a propagation signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication apparatus that communicates with a plurality of transmission sources, the communication apparatus comprising:
an interface that receives from a given transmission source among the transmission sources, a request notification that concerns a transmission right permitting transmission from the given transmission source to the communication apparatus and that includes information identifying a volume of data to be transmitted to the communication apparatus; and
a processor that based on the received request notification, judges whether the given transmission source is to be granted the transmission right, wherein
the interface transmits the transmission right to the given transmission source that has been judged to be granted the transmission right.

2. The communication apparatus according to claim 1, wherein
the processor, based on the information identifying the data volume of the data to be transmitted to the communication apparatus and information identifying the volume of data that is at another transmission source and is to be transmitted to the communication apparatus, judges whether the given transmission source is to be granted the transmission right.

3. The communication apparatus according to claim 1, wherein
the request notification received by the interface includes information identifying the volume of data to be transmitted to another communication apparatus that is different from the communication apparatus, and
the processor, based on the information identifying the data volume of the data to be transmitted to the communication apparatus and the information identifying the data volume of the data to be transmitted to the other communication apparatus, judges whether the given transmission source is to be granted the transmission right.

4. The communication apparatus according to claim 1, wherein
the processor judges that the given transmission source is not to be granted the transmission right, when the transmission sources that have been granted the transmission right are of a number that is greater than or equal to a threshold.

5. The communication apparatus according to claim 1, wherein
the request notification received by the interface includes information related to a transmission time limit that is for the data that is at the given transmission source and to be transmitted to the communication apparatus, and
the processor, based on the information related to the transmission time limit and information related to a transmission time limit for data that is to be transmitted to the communication apparatus and is at another transmission source, judges whether the given transmission source is to be granted the transmission right.

6. The communication apparatus according to claim 1, wherein
the processor based on the request notification received by the interface, determines a permissible data volume of the data to be transmitted by the given transmission source that has been judged by the processor to be granted the transmission right, and
the interface transmits to the given transmission source judged to be granted the transmission right, the transmission right that includes the determined permissible data volume.

7. A communication apparatus that communicates with a plurality of destinations, the communication apparatus comprising:
a processor that:
based on a volume of data to be transmitted to a given destination among the destinations, judges whether to request from the given destination, a transmission right permitting transmission from the communication apparatus to the given destination, and
upon judging that the transmission right is to be requested, notifies the given destination of a request notification that includes information identifying the volume of the data to be transmitted to the given destination;
an interface that:
receives the transmission right from the given destination as a result of the request notification, and
upon receiving the transmission right, transmits to the given destination, the data that is to be transmitted to the given destination.

8. The communication apparatus according to claim 7, wherein
the processor, when the volume of the data to be transmitted to the given destination is greater than or equal to a threshold, judges that the transmission right is to be requested of the given destination.

9. The communication apparatus according to claim 7, wherein
the processor:
measures time elapsing since generation of the data to be transmitted to the given destination, and
notifies the given destination of the request notification, when the elapsed time measured by the processor is greater than or equal to a threshold that is based on a transmission time limit of the data that is to be transmitted to the given destination.

10. The communication apparatus according to claim 7, wherein
the request notification includes information related to a transmission time limit of the data to be transmitted to the given destination.

11. The communication apparatus according to claim 7, wherein
the request notification includes information indicating the volume of the data to be transmitted to another destination that is different from the given destination.

12. The communication apparatus according to claim 7, wherein
the transmission right includes a permissible data volume of the data to be transmitted, and
the interface, among the data to be transmitted to the given destination, transmits the permissible data volume or less to the given destination.

13. A communication method performed by a communication apparatus that communicates with a plurality of transmission sources, the communication method comprising:
receiving from a given transmission source among the transmission sources, a request notification that concerns a transmission right permitting transmission from the given transmission source to the communication apparatus and that includes information identifying a volume of data to be transmitted to the communication apparatus;
judging based on the request notification, whether the given transmission source is to be granted the transmission right; and
transmitting the transmission right to the given transmission source that has been judged to be granted the transmission right.

14. A communication method performed by a communication apparatus that communicates with a plurality of destinations, the communication method comprising:
judging based on a volume of data to be transmitted to a given destination among the destinations, whether to request from the given destination, a transmission right permitting transmission from the communication apparatus to the given destination;
notifying the given destination of a request notification that includes information identifying the volume of the data to be transmitted to the given destination, when the processor judges that the transmission right is to be requested;
receiving the transmission right from the given destination as a result of the request notification at the notifying; and
transmitting to the given destination and when the transmission right is received by the interface, the data that is to be transmitted to the given destination.

15. A computer-readable medium storing therein a communication program that causes a communication apparatus that communicates with a plurality of transmission sources to execute a process, the process comprising:
receiving from a given transmission source among the transmission sources, a request notification that concerns a transmission right permitting transmission from the given transmission source to the communication apparatus and that includes information identifying a volume of data to be transmitted to the communication apparatus;
judging based on the request notification, whether the given transmission source is to be granted the transmission right; and
transmitting the transmission right to the given transmission source that has been judged to be granted the transmission right.

16. A computer-readable medium storing therein a communication program that causes a communication apparatus that communicates with a plurality of destinations to execute a process, the process comprising:
judging based on a volume of data to be transmitted to a given destination among the destinations, whether to request from the given destination, a transmission right permitting transmission from the communication apparatus to the given destination;
notifying the given destination of a request notification that includes information identifying the volume of the data to be transmitted to the given destination, when the processor judges that the transmission right is to be requested;
receiving the transmission right from the given destination as a result of the request notification at the notifying; and
transmitting to the given destination and when the transmission right is received by the interface, the data that is to be transmitted to the given destination.
